(19) United States
(12) Patent Application Publication
(10) Pub. No.: US 2006/0001776 A1
(43) Pub. Date: Jan. 5, 2006

(54) Television receiver

(75) Inventor: Shoji Araki, Honjo-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/170,744

(22) Filed: Jun. 30, 2005

(30) Foreign Application Priority Data
Jun. 30, 2004 (JP) 2004-194567

(51) Int. Cl. H04N 3/27; H04N 5/268

(52) U.S. Cl. 348/705; 348/554

(57) ABSTRACT

A television receiver has an HDMI input terminal and a DVI input terminal and reproduces an HDMI signal or a DVI signal without switching between an HDMI device and a DVI device for connection to the television receiver. The HDMI signal or the DVI signal is input through a changeover switch to an HDMI signal processing unit. The changeover switch is controlled by a CPU.

### CROSS-REFERENCE TO RELATED APPLICATIONS

This application is based upon and claims the benefit of priority from prior Japanese Patent Application No. 2004-194567, filed Jun. 30, 2004, the entire contents of which are incorporated herein by reference.

### BACKGROUND OF THE INVENTION

1. Field of the Invention

The present invention relates to a television receiver which is equipped with a plurality of digital interface terminals as signal input terminals to receive video signals and which selects one of the input video signals and displays the selected video signal with sound.

2. Description of the Related Art

A conventional television receiver is equipped with an input terminal connected to receive an analog video signal as an external input signal. The television receiver receives an analog video signal from external equipment, such as a VTR, and displays images based on the analog video signal.

In recent years, digital video signal transferring interfaces which are applied to personal computer (PC) displays have been standardized as the digital video interface (DVI). In Japanese Unexamined Patent Publication No. 2003-233364, an image display device is described which is adapted to receive a DVI video signal and display corresponding images.

Recently, digital interfaces for the next-generation of television have been standardized as the high-definition multimedia interface (HDMI).

Conventional television receivers having the digital interface are equipped with a single interface terminal, such as a HDMI terminal or a DVI terminal. In order to connect a DVI device to a television receiver having an HDMI terminal alone, it is required to use an HDMI-DVI conversion cable, i.e., an adapter. Likewise, in order to connect an HDMI device to a television receiver having a DVI terminal alone, a conversion cable is required. That is, to switch between the HDMI and the DVI device on the signal transmission side, it is required to pull out/pull in a connector of the conversion cable.

### BRIEF SUMMARY OF THE INVENTION

According to an aspect of the invention, there is provided a television receiver comprising: a first digital interface terminal connected to receive a first digital signal; a second digital interface terminal connected to receive a second digital signal different from the first digital signal in data structure; a selecting unit which selects and outputs one of the first digital signal input through the first digital interface terminal and the second digital signal input through the second digital interface terminal; a signal extraction unit including a video output unit which extracts and outputs a video signal contained in a digital signal selected by the selecting unit and an audio output unit which extracts and outputs an audio signal contained in the digital signal selected by the selecting unit; a display unit which displays images based on the video signal extracted by the signal extraction unit; and an audio output unit which outputs sound based on the audio signal extracted by the signal extraction unit.

According to another aspect of the invention, a television receiver has an HDMI input terminal and a DVI input terminal and reproduces an HDMI signal or a DVI signal without switching between an HDMI device and a DVI device for connection to the television receiver. The HDMI signal or the DVI signal is input through a changeover switch to an HDMI signal processing unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a television receiver according to an embodiment of the present invention;

FIG. 2 shows the arrangement of data transferred through HDMI;

FIG. 3 is a block diagram of the HDMI signal processing unit shown in FIG. 1; and

FIG. 4 is a flowchart illustrating the switching process performed by the CPU using the changeover switch shown in FIG. 4.

### DETAILED DESCRIPTION OF THE INVENTION

An embodiment of the present invention will be described in detail below with reference to the accompanying drawings.

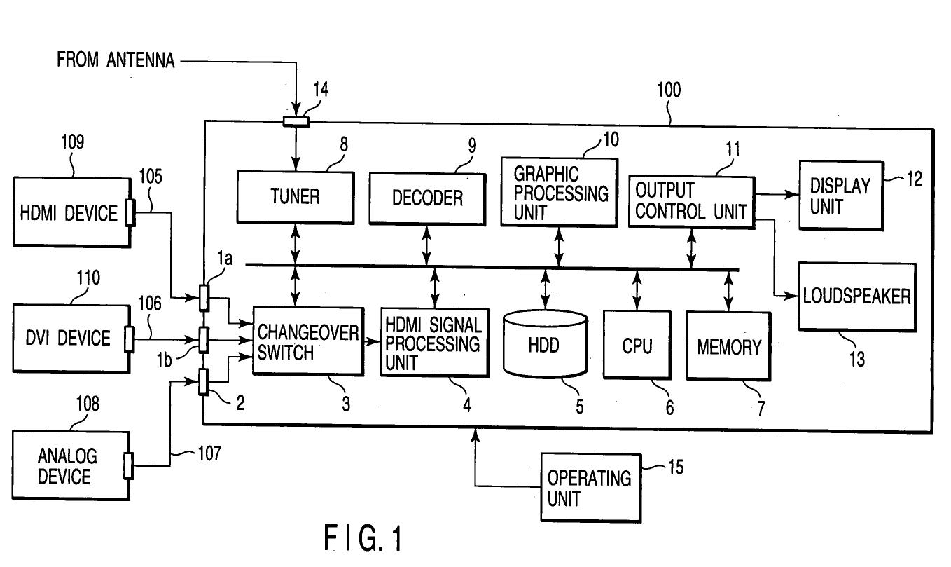

FIG. 1 is a block diagram of a television receiver according to an embodiment of the present invention. The television receiver, indicated generally at 100, includes an HDMIT input terminal 1a, a DVI input terminal 1b, an analog signal input terminal 2, a changeover switch 3, an HDMI signal processing unit 4, an HDD 5, a memory 7, a tuner 8, a decoder 9, a graphics processing unit 10, an output control unit 11, a display unit 12, a loudspeaker 13, an antenna input terminal 14, and an operating unit 15.

The operating unit 15 is equipped with various keys which accept a variety of input operations and is, for example, a remote controller. The CPU 6 responds to input signals from the operating unit 15 to control the components in the television receiver 100. The memory 7 includes a ROM storing various control programs and a RAM used as a working area for the CPU 6.

An HDMI device 109 is connected to the television receiver 100 by an HDMI dedicated cable 105. A DVI device 110 is connected to the television receiver 100 by a DVI dedicated cable 106. An analog device 108 is connected to the television receiver 100 by an analog signal cable 107.

The HDMI input terminal 1a is connected to receive an HDMI signal (video and audio data) from the HDMI device 109. The DVI input terminal 1b is connected to receive a DVI signal (video data) from the DVI device 110. The analog input terminal 2 is connected to receive an analog signal (video and audio signals) from the analog device 111.

The HDMI signal from the HDMI input terminal 1a, the DVI signal from the DVI input terminal 1b and the analog signal from the analog input terminal 2 are applied to the changeover switch 3 as external input signals. The changeover switch makes a selection from the HDMI signal from the HDMI input terminal 1a, the DVI signal from the DVI input terminal 1b and the analog signal from the analog input terminal 2. When selecting the HDMI signal or the DVI signal, the changeover switch 3 sends the selected signal to the HDMI signal processing unit 4. When the changeover switch 3 selects the analog signal, it is sent to the output control unit 11.

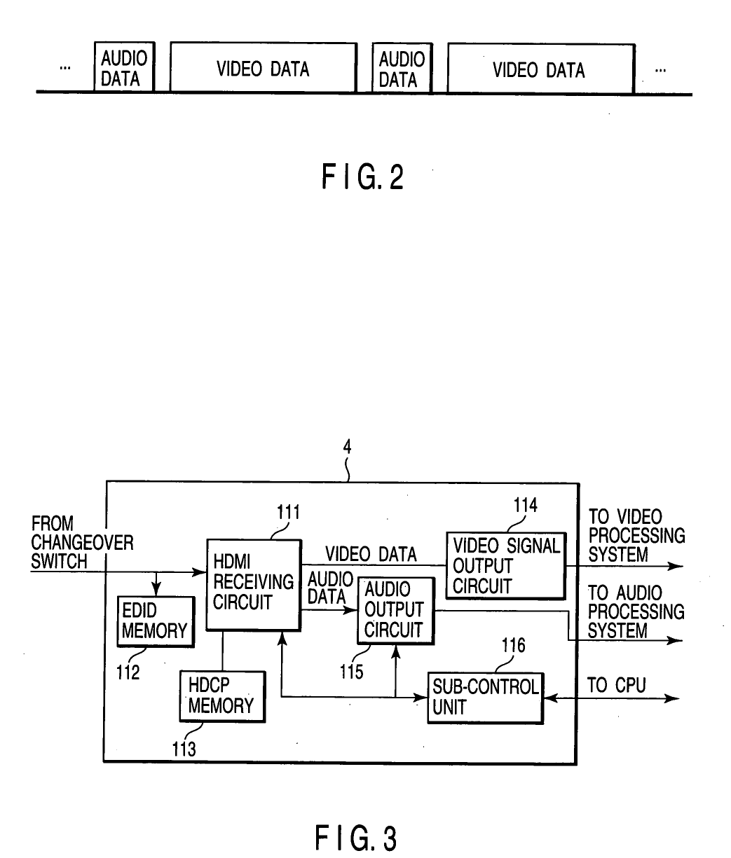

The DVI is the interface for serially transferring digital video data to a PC display or the like. The HDMI is the interface standardized with the DVI as a basis to transfer digital video data and digital audio data. With the HDMI, video data and audio data are transferred serially (as one bit serial data) on a time division multiplexed basis as shown in FIG. 2. The HDMI device 109 is an AV (audio visual) device, such as a digital versatile disk (DVD) player or a set-top box (STB). The DVI device 110 is, for example, a personal computer (PC). The analog device 108 is, for example, a videotape recorder (VTR).

The input terminal 14 is connected to receive broadcast signals received by an antenna not shown. The tuner 8 extracts specific program data from broadcast signals input to the input terminal 14. The tuner 8, which is a digital tuner adapted to receive digital broadcasts, such as digital DBS broadcasts, has a function of receiving analog terrestrial broadcasts as well. Program data extracted by the tuner 8 is decoded by the decoder 9. The hard disk drive (HDD) 5 records video and audio data from the HDMI signal processing unit 4 or the tuner 8.

The output control unit 11 performs analog-to-digital conversion and amplification processing on the input signal if it is a digital signal. If the input signal is an analog signal, the output control unit performs amplification processing on it. The video signal processed by the output control unit 11 is applied to the display unit 12 and displayed. The audio signal is applied to the loudspeaker 13 to output sound.

The graphics processing unit 10 produces display data used in displaying various setting screens of the television receiver 100 which are made up of characters and lines on the display unit 12. The display data produced by the graphics processing unit 10 is combined with video data, such as program data, in the output control unit 11 and then displayed on the display unit 12.

The HDMI signal processing unit 4 will be described next. The HDMI signal processing unit 4 outputs video and audio signals when the input signal is an HDMI signal and outputs only a video signal when the input signal is a DVI signal.

FIG. 3 is a block diagram of the HDMI signal processing unit 4. The HDMI signal processing unit 4 includes an HDMI receiving circuit 111, an EDID memory 112, an HDCP memory 113, a video signal output circuit 114, an audio signal output circuit 115, and a sub-control unit 116.

The EDID memory 112 stores control data associated with display. The extended display identification data (EDID) is data for allowing the host side (the HDMI device 109 and the DVI device 110) to recognize information (resolution, the number of pixels, etc.) on the display side (the display unit 12). The high-band digital content protection (HDCP) memory 113 stores key data for controlling copy protection of digital input signals input via the changeover switch 3. The sub-control unit 116 controls the HDMI signal processing unit 4 on the basis of commands from the CPU 6.

The HDMI receiving circuit 111 extracts a video signal from a digital signal selected by the changeover switch 3 and outputs it to the output control unit 11 through the video signal output circuit 114. In addition, the HDMI receiving circuit 111 extracts an audio signal from the digital signal selected by the changeover switch 3 and outputs it to the output control unit 11 through the audio signal output circuit 115. The video data and the audio data output from the HDMI receiving circuit 111 are parallel data each of multiple bits.

The video signal output circuit 114 and the audio signal output circuit 115 may each include a digital-to-analog converter. In such a case, each of the analog signals output from the video signal output circuit 114 and the audio signal output circuit 115 is amplified in the output control unit 12 and then applied to a corresponding one of the display unit 12 and the loudspeaker 13.

The signal switching process of the present invention will be described next.

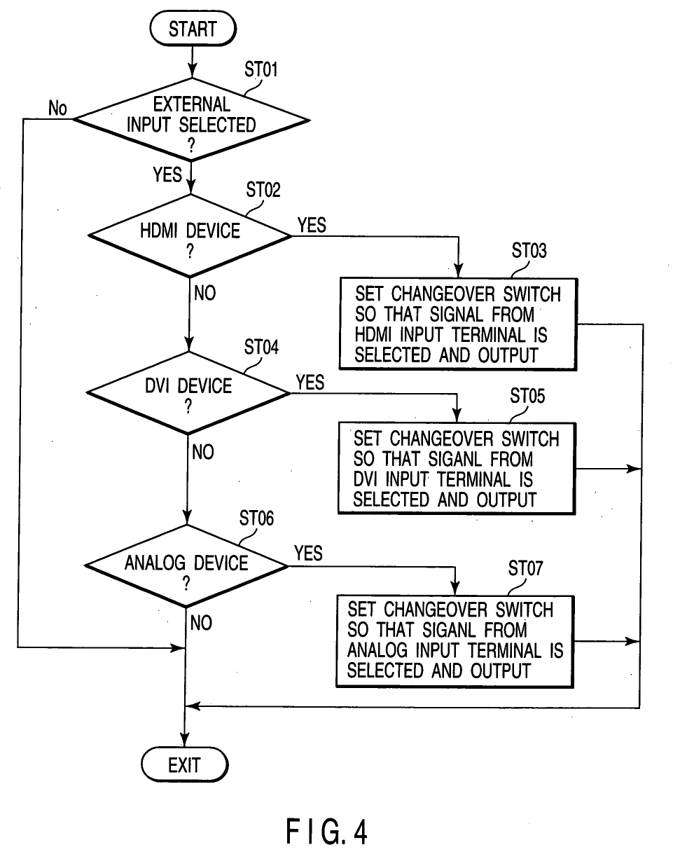

FIG. 4 is a flowchart illustrating the switching process performed by the CPU 6 using the changeover switch 3.

The CPU 6 waits for an external input selecting command from the user via the operating unit 15 (step ST01). Upon receiving such a command (YES in step ST01), the CPU 6 makes a decision of whether a signal from the HDMI device is input (step ST02). If a signal from the HDMI device is input, the CPU 6 sets the changeover switch 3 so that a signal from the HDMI input terminal is selected and output (step ST03). The signal selected by the changeover switch 3 is applied to the HDMI signal processing unit 4.

If NO in decision step ST02, the CPU 6 decides whether a signal from the DVI device is input (step ST04). If a signal from the DVI device is input, the CPU 6 sets the changeover switch 3 so that a signal from the DVI input terminal is selected and output (step ST05).

If NO in decision step ST04, the CPU 6 decides whether a signal from the analog device is input (step ST06). If a signal from the analog device is input, then the CPU 6 sets the changeover switch 3 so that a signal from the analog input terminal is selected and output (step ST07).

Thus, a signal applied to one of the terminals 1a, 1b and 2 can be automatically selected. In the event that a plurality of signals are applied to the input terminals 1a, 1b and 2, an image which prompts the user to select one of the input signals may be produced by the graphics processing unit 10 and displayed on the display unit 12. When the user selects one of the input signals through the operating unit, the changeover switch is operated to select one of the input signals applied to the input terminals. When signals are applied to at least two of the input terminals 1a, 1b and 2, a specific one of the devices (e.g., the HDMI device) may be selected by priority.

According to the present invention, as described above, video and audio signals can be reproduced by merely connecting an HDMI device and a DVI device to a television receiver by their respective dedicated cables but not by conversion cables.

In addition, since either of HDMI and DVI signals can be selected by the changeover switch 3 and moreover video can be reproduced using the common signal processing unit 4, the circuit arrangement will not become complicated due to signal switching. That is, an increase in the cost of the television receiver can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A television receiver comprising:
a first digital interface terminal configured to receive a first digital signal;
a second digital interface terminal configured to receive a second digital signal different from the first digital signal in data structure;
a selecting unit which selects and outputs one of the first digital signal input through the first digital interface terminal and the second digital signal input through the second digital interface terminal;
a signal extraction unit including a video output unit which extracts and outputs a video signal contained in a digital signal selected by the selecting unit and an audio output unit which extracts and outputs an audio signal contained in the digital signal selected by the selecting unit;
a display unit which displays images based on the video signal extracted by the signal extraction unit; and
an audio output unit which outputs sound based on the audio signal extracted by the signal extraction unit.

2. A television receiver according to claim 1, wherein the first digital signal contains a video signal and an audio signal and the second digital signal contains video signal.

3. The television receiver according to claim 2, further comprising a control unit which detects which of the first and second digital interface terminals is receiving a digital signal and causes the selecting unit to select and output the digital signal that the detected digital interface terminal is receiving.

4. A television receiver comprising:
HDMI input terminal which receive a first digital signal having a HDMI (high-definition multimedia interface) standard format;
DVI input terminal which receive a second digital signal having a DVI (digital video interface) standard format;
a selecting unit which selects and outputs one of the first digital signal received by the HDMI terminal and the second digital signal received by the DVI terminal;
a signal extraction unit which extracts and outputs a video signal from the digital signal selected by the selecting unit and extracts and outputs an audio signal from the first digital signal when the selecting unit selects the first digital signal;
a display unit which displays images based on the video signal extracted by the signal extraction unit; and
an audio output unit which outputs sound based on the audio signal extracted by the signal extraction unit.

5. The television receiver according to claim 4, further comprising a control unit which detects which of the HDMI and DVI terminals is receiving a digital signal and causes the selecting unit to select and output the digital signal that the detected digital interface terminal is receiving.
